(19) United States
(12) Patent Application Publication
(10) Pub. No.: US 2013/0031344 A1
(43) Pub. Date: Jan. 31, 2013

(54) COMPUTER AND DISPLAY AND BOOT CIRCUIT FOR SAME

(71) Applicants: KANG WU, Shenzhen City (CN); BO TIAN, Shenzhen City (CN)

(72) Inventors: KANG WU, Shenzhen City (CN); BO TIAN, Shenzhen City (CN)

(73) Assignees: HON HAI PRECISION INDUSTRY CO., LTD., Tu-Cheng (TW); HONG FU JIN PRECISION INDUSTRY (ShenZhen) CO.,LTD., Shenzhen City (CN)

(21) Appl. No.: 13/447,323

(22) Filed: Apr. 16, 2012

(30) Foreign Application Priority Data
Jul. 28, 2011 (CN) 201110213404.5

(51) Int. Cl. G06F 9/00

(52) U.S. Cl. 713/2

(57) ABSTRACT

A computer system includes a display and a computer. The display includes a first data port, a boot button connected to a first pin of the first data port, and a display control circuit connected to the boot button. The computer includes a second data port connected to the first data port, a buffer connected to a second pin of the second data port, and a computer control circuit. When the boot button is turned on, the display control circuit receives a low-level signal. The display control circuit boots the display, and controls the display to operate. The computer control circuit receives the low-level signal through the first and second data ports, and the buffer. The computer control circuit boots the computer, and controls the computer to operate.

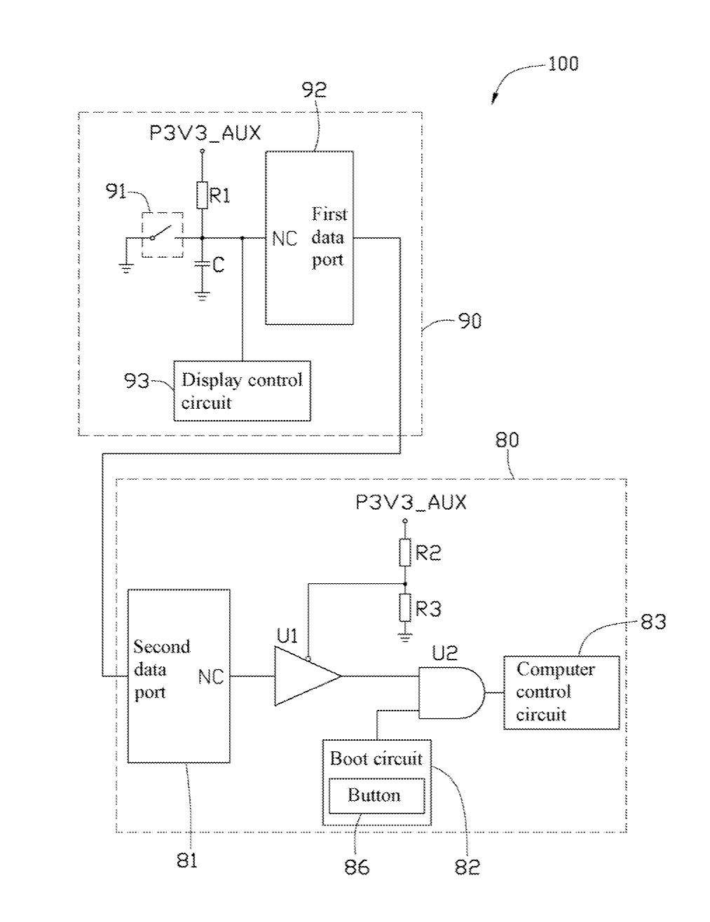

### BACKGROUND

1. Technical Field

The present disclosure relates to a computer, a display and a boot circuit for same.

2. Description of Related Art

Many computers have a separate display with its own start-up button. So a user must push the start buttons for both the display and the computer to turn each of them on, which is inconvenient.

### BRIEF DESCRIPTION OF THE DRAWING

Many aspects of the embodiments can be better understood with reference to the following drawing. The components in the drawing are not necessarily drawn to scale, the emphasis instead being placed upon clearly illustrating the principles of the present embodiments.

The FIGURE is a circuit diagram of an exemplary embodiment of a computer system.

### DETAILED DESCRIPTION

The disclosure, including the accompanying drawing, is illustrated by way of example and not by way of limitation. It should be noted that references to “an” or “one” embodiment in this disclosure are not necessarily to the same embodiment, and such references mean at least one.

Referring to the figure, an exemplary embodiment of a computer system 100 includes a display 90 and a computer 80. In generic technology, a data port of each of the display 90 and the computer 80 includes an idle pin NC. In this embodiment, the pin NC of the display 90 is used to transmit a boot signal to the pin NC of the computer 80. Detailed descriptions are as follows.

The display 90 includes a first data port 92, a boot button 91, a resistor R1, a capacitor C, and a display control circuit 93 connected to the boot button 91. The pin NC of the first data port 92 is connected to a power supply P3V3_AUX through the resistor R1, and is grounded through the capacitor C. The pin NC of the first data port 92 is further grounded through the boot button 91, and is further connected to the display control circuit 93.

The computer 80 includes a second data port 81 to be connected to the first data port 92, a buffer U1, an AND gate U2, a boot circuit 82 with a button 86, a computer control circuit 83, and resistors R2 and R3. The pin NC of the second data port 81 is connected to an input terminal of the buffer U1. The power supply P3V3_AUX is grounded through the resistors R2 and R3 connected in series. A control terminal of the buffer U1 is connected with a node between the resistors R2 and R3. An output terminal of the buffer U1 is connected to a first input terminal of the AND gate U2. A second input terminal of the AND gate U2 is connected to the boot circuit 82. An output terminal of the AND gate U2 is connected to the computer control circuit 83.

When the first data port 92 is connected to the second data port 81, the pin NC of the second data port 81 is connected to the pin NC of the first data port 92. In this embodiment, the first and second data ports 92 and 81 comply with Serial Attached Small Computer System Interface (SAS) standards.

When the boot button 91 is turned on, the pin NC of the first data port 92 and the display control circuit 93 are both grounded through the boot button 91. The display control circuit 93 boots the display 90. At the same time, the input terminal of the buffer U1 is grounded through the pins NC of the first and second data ports 92 and 81 and the voltage at the input terminal is logic low.

When the computer 80 is off, the power supply P3V3_AUX does not supply power to the control terminal of the buffer U1, thus voltage at the control terminal of the buffer U1 is a low-level signal, which turns on the buffer U1. When the boot button 91 is pushed to start up the computer system, the low-level signal at the input terminal of the buffer U1 is transmitted to the first input terminal of the AND gate U2 through the output terminal of the buffer U1. The AND gate outputs a low-level signal to the computer control circuit 83. The computer control circuit 83 boots the computer 80. In this way, the display 90 and the computer 80 may start up simultaneously by turning just the one boot button 91 on.

When the computer 80 is operating, the power supply P3V3_AUX supplies power to the control terminal of the buffer U1, thus a signal at the control terminal of the buffer U1 is a high-level signal, which keeps the buffer U1 off. Therefore, no signals may reach the first input terminal of the AND gate U2 through the buffer U1. When the boot button 91 is turned off, the display control circuit 93 receives a high-level signal output by the power supply P3V3_AUX. The display 90 is turned off by the display control circuit 93. However, the computer 83 and thus the computer still operates because the buffer U1 is off. In this way, the display 90 can be turned off or turned on by turning the boot button 91 off or on while leaving the computer on. Turning off the computer can be done through software commands or by operating a power button on the computer.

In addition, the computer 80 can be booted in any suitable way known in the art. When the computer 80 is off, the boot circuit 82 may output a low-level signal to the second input terminal of the AND gate U2 by turning the button 86 on. The AND gate U2 outputs a low-level signal to the computer control circuit 83. The computer control circuit 83 boots the computer 80, and controls the computer 80 to operate.

The foregoing description of the exemplary embodiments of the disclosure has been presented only for the purposes of illustration and description and is not intended to be exhaustive or to limit the disclosure to the precise forms disclosed. Many modifications and variations are possible. The embodiments were chosen and described in order to explain the principles of the disclosure and their practical application so as to enable others of ordinary skill in the art to utilize the disclosure and various embodiments and with such various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than by the foregoing description and the exemplary embodiments described therein.

What is claimed is:

1. A computer system, comprising:
a display, comprising:
a boot button;
a first data port with a first pin, wherein the first pin is grounded through the boot button, and is further connected to a power supply through a first resistor; and
a display control circuit, connected to the first pin of the first data port; and
a computer, comprising:
a second data port with a second pin, wherein when the second data port is connected to the first data port, the second pin is connected to the first pin of the first data port;
a buffer with an input terminal, a control terminal, and an output terminal, the input terminal connected to the second pin of the second data port, the control terminal connected to the power supply; and
a computer control circuit, connected to the output terminal of the buffer;
wherein when the boot button is turned on, the display control circuit and the first pin of the first data port both receive a low-level signal, the display control circuit boots the display, and controls the display to operate, when the computer is powered off, a signal at the control terminal of the buffer is a low-level signal, the buffer is turned on, the low-level signal outputted by the second pin of the second data port is transmitted to the computer control circuit through the buffer, the computer control circuit boots the computer, and controls the computer to operate.

2. The computer system of claim 1, further comprising an AND gate, and a boot circuit with a button, wherein a first input terminal of the AND gate is connected to the output terminal of the buffer, a second terminal of the AND gate is connected to the boot circuit, an output terminal of the AND gate is connected to the computer control circuit, when the button is turned on, the boot circuit outputs a low-level signal to the second input terminal of the AND gate.

3. The computer system of claim 1, further comprising a capacitor connected between the first pin of the first data port and ground.

4. The computer system of claim 1, further comprising second and third resistors, wherein the second resistor is connected between the power supply and the control terminal of the buffer, the control terminal of the buffer is grounded through the third resistor.

5. The computer system of claim 1, wherein the first and the second data ports comply with a Serial Attached Small Computer System Interface standard.
